(19) United States
(12) Patent Application Publication
(10) Pub. No.: US 2024/0208673 A1
(43) Pub. Date: Jun. 27, 2024

(54) INFORMATION PROCESSING DEVICE, INFORMATION PROCESSING METHOD, AND NON-TRANSITORY COMPUTER READABLE MEMORY

(71) Applicant: Rakuten Group, Inc., Tokyo (JP)

(72) Inventors: Asaki Matsumoto, Tokyo (JP); Masato Tani, Tokyo (JP); Takayoshi Inuma, Tokyo (JP)

(73) Assignee: Rakuten Group, Inc., Tokyo (JP)

(21) Appl. No.: 18/539,440

(22) Filed: Dec. 14, 2023

(30) Foreign Application Priority Data
Dec. 22, 2022 (JP) 2022-205675

(51) Int. Cl. B64F 5/60; G06F 21/31

(52) U.S. Cl. CPC B64F 5/60; G06F 21/31

(57) ABSTRACT

The base management server MS performs the login processing of the worker Wm in response to the login request from the worker terminal Tm used by the worker Wm, identifies the drone base Bm that the worker Wm is in charge of when the worker Wm logs in by the login processing, and displays the drone list including the inspection status of each drone Dn under the control of the identified drone base Bm on the worker terminal Tm.

### CROSS REFERENCE TO RELATED APPLICATION

This application claims priority from Japanese Patent Application No. 2022-205675 which was filed on Dec. 22, 2022, the disclosure of which is herein incorporated by reference in its entirety.

### TECHNICAL FIELD

One or more embodiments of the present invention relates to a technical field such as a system capable of efficiently inspecting an unmanned aerial vehicle.

### RELATED ART

Conventionally, known is a technique in which an unmanned aerial vehicle such as a drone performs automatic inspection before take-off thereof. For example, a drone disclosed in JP 2021-191675 A includes a vehicle position confirmation unit, a nose confirmation unit, a peripheral confirmation unit, and the like as a configuration for diagnosing, before take-off of the drone, whether conditions for safe flight and chemical spraying are satisfied. Furthermore, the drone includes a vehicle visual confirmation unit, and the vehicle visual confirmation unit has a function of instructing a user to visually confirm a point through a pilot device. As a result, the user can efficiently inspect the drone.

Meanwhile, in a base where a plurality of unmanned aerial vehicles can take off and land, for example, in order for a worker to efficiently inspect the plurality of unmanned aerial vehicles, it is necessary to grasp a current state such as an execution status of an inspection of the unmanned aerial vehicle managed by the base. However, when the number of unmanned aerial vehicles controlled by the base increases, the worker cannot fully grasp the current state of each unmanned aerial vehicle and, as such, efficiency of the inspection of each unmanned aerial vehicle deteriorates.

Therefore, one or more embodiments of the present invention are to providing an information processing device, an information processing method, and a non-transitory computer readable memory, capable of improving efficiency of inspection for a plurality of unmanned aerial vehicles under the control of a base.

### SUMMARY

(An aspect 1) In response to the above issue, an information processing device includes: at least one memory configured to store program code; and at least one processor configured to access the program code and operate as instructed by the program code. The program code includes: login processing code configured to cause the at least one processor to perform login processing of a worker who performs an inspection for an unmanned aerial vehicle at a base where the unmanned aerial vehicle is allowed to take off or land in response to a login request from a terminal used by the worker; base identification code configured to cause the at least one processor to identify, when the worker logs in by the login processing, the base that the worker is in charge of; and display control code configured to cause the at least one processor to display, on the terminal, a list including respective current states of a plurality of the unmanned aerial vehicles under control of the identified base.

(An aspect 2) An information processing method executed by one or more computers, includes: performing login processing of a worker who performs an inspection for an unmanned aerial vehicle at a base where the unmanned aerial vehicle is allowed to take off or land in response to a login request from a terminal used by the worker; identifying, when the worker logs in by the login processing, the base that the worker is in charge of; and displaying, on the terminal, a list including respective current states of a plurality of the unmanned aerial vehicles under control of the identified base.

(An aspect 3) A non-transitory computer readable memory has stored thereon a program configured to cause a computer to: perform login processing of a worker who performs an inspection for an unmanned aerial vehicle at a base where the unmanned aerial vehicle is allowed to take off or land in response to a login request from a terminal used by the worker; identify, when the worker logs in by the login processing, the base that the worker is in charge of; and display, on the terminal, a list including respective current states of a plurality of the unmanned aerial vehicles under control of the identified base.

### BRIEF DESCRIPTION OF THE DRAWINGS

FIG. 1 is a diagram illustrating a schematic configuration example of a drone base system S.

FIG. 2 is a diagram illustrating a schematic configuration example of a drone Dn.

FIG. 3 is a diagram illustrating a schematic configuration example of a worker terminal Tm.

FIG. 4 is a diagram illustrating an example of a drone list screen.

FIG. 5 is a diagram illustrating an example of a pre-flight check screen for a drone D3.

FIG. 6 is a diagram illustrating an example of a pre-flight check screen for a drone D4.

FIG. 7 is a diagram illustrating a schematic configuration example of a base management server MS.

FIG. 8 is a diagram illustrating an example of functional blocks in a control unit 33.

FIG. 9 is a sequence diagram illustrating an example of drone list display processing executed by the worker terminal T1 and the base management server MS.

FIG. 10 is a flowchart illustrating an example of retreat notification processing executed by the base management server MS.

### DETAILED DESCRIPTION

Hereinafter, one or more embodiments of the present invention will be described with reference to the drawings. Incidentally, the following embodiment is an embodiment in a case where the present invention is applied to a drone base system used in a base (hereinafter referred to as a “drone base”) where a plurality of drones can take off and land.

### 1. Configuration and Operation Outline of Drone Base System S

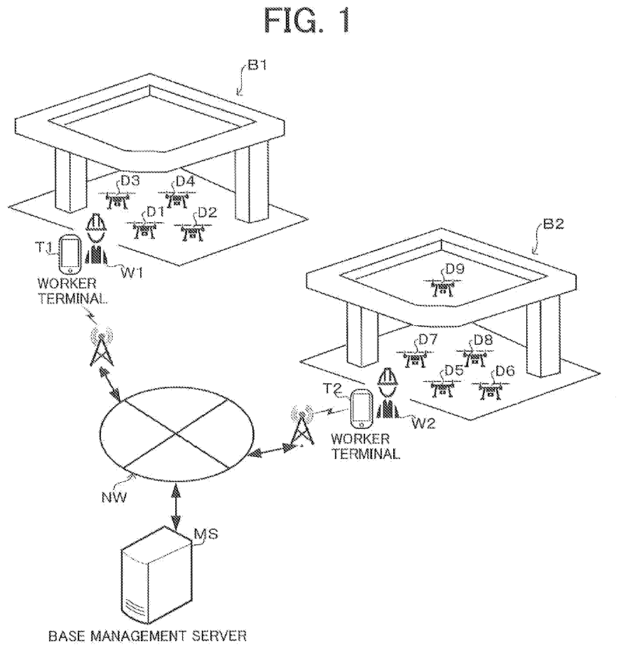

First, a description will be given as to a configuration and an operation outline of a drone base system S according to the present embodiment with reference to FIG. 1. FIG. 1 is a diagram illustrating a schematic configuration example of the drone base system S. As illustrated in FIG. 1, the drone base system S includes a plurality of drones Dn (n=1, 2, 3 . . . ), a plurality of worker terminals Tm (m=1, 2 . . . ), a base management server MS (an example of an information processing device), and the like. Each of the drone Dn, the worker terminal Tm, and the base management server MS is connected to a communication network NW. The communication network NW includes, for example, the Internet, a mobile communication network and a radio base station thereof, and the like.

The drone Dn is an example of an unmanned flying object, and is also referred a multi-copter or a UAV (Unmanned Aerial Vehicle). The drone Dn can fly according to remote control by an operator from the ground or autonomously fly, and is used for, for example, delivery, surveying, photographing, monitoring, and the like. The drone Dn is managed by a GCS (Ground Control Station) connected to the communication network NW. For example, the GCS may be mounted as an application on a pilot terminal, or may be configured by one or more servers or the like.

Moreover, the drone Dn is under the control (in other words, jurisdiction) of any one of the plurality of drone bases Bm. In the example of FIG. 1, each of the drones D1 to D4 is under the control of a drone base B1, departs (takes off) from the drone base B1, and returns (lands) to the drone base B1. Moreover, each of the drones D5 to D9 is under the control of a drone base B2, departs from the drone base B2, and returns to the drone base B2. Incidentally, the number of drones Dn managed by one drone base Bm is not particularly limited.

The worker terminal Tm is a terminal used by a worker (a base staff) Wm who inspects the drone Dn in the drone base Bm. For example, the worker Wm visually inspects a predetermined portion of the drone Dn or touches and inspects a predetermined portion of the drone Dn. The inspection of the drone Dn performed by the worker W in this manner is hereinafter referred to as “manual inspection”. In the example of FIG. 1, a worker terminal T1 is used by a worker W1 who performs the manual inspection at the drone base B1. Moreover, a worker terminal T2 is used by a worker W2 who performs the manual inspection at the drone base B2. Incidentally, a plurality of workers Wm may stay at (belong to) one drone base Bm to perform work including the manual inspection.

The base management server MS is composed of one or a plurality of server computers that manages information on the drone base Bm for each drone base Bm. The information on the drone base Bm includes, for example, information on the drone Dn under the control of the drone base Bm, the worker terminal Tm used in the drone base Bm, and information on the worker Wm who uses the worker terminal Tm. The base management server MS can identify the drone base Bm (a base in charge) that the worker Wm who logs in by operating the worker terminal Tm is in charge of, and display, on the worker terminal Tm, a list (hereinafter, referred to as a “drone list”) including a current state (for example, a status related to inspection, hereinafter referred to as “inspection status”) of each of the plurality of drones Dn under the control of the identified drone base Bm.

### [1-1. Configuration and Function of Drone Dn]

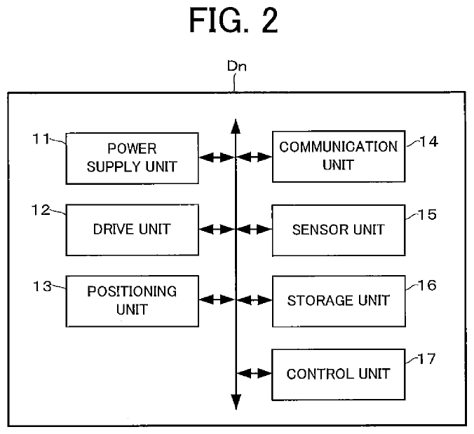

Next, a configuration and a function of the drone Dn will be described with reference to FIG. 2. FIG. 2 is a diagram illustrating a schematic configuration example of the drone Dn. As illustrated in FIG. 2, the drone Dn includes a power supply unit 11, a drive unit 12, a positioning unit 13, a communication unit 14, a sensor unit 15, a storage unit 16, a control unit 17, and the like. Furthermore, the drone Dn includes a propeller (a rotor), which is a horizontal rotary wing, an arm pipe (including an arm joint) for attaching the propeller to a drone main body (a housing), and the like. Incidentally, in a case where the drone Dn is used for delivery of an article, the drone Dn includes a holding mechanism or the like for holding the article.

The power supply unit 11 includes a detachable battery (an electric storage device) and the like. The power supply unit 11 supplies (supplies electricity) power stored in the battery to each unit of the drone Dn. Moreover, the power supply unit 11 sequentially measures a remaining battery capacity. Battery information indicating the remaining battery capacity measured by the power supply unit 11 is output to the control unit 17. The drive unit 12 includes a motor, a rotation shaft, and the like. The drive unit 12 rotates the plurality of rotors by a motor, a rotation shaft, and the like that are driven in accordance with a control signal output from the control unit 17.

The positioning unit 13 includes a radio wave receiver, an altitude sensor, and the like. The positioning unit 13 receives, for example, a radio wave transmitted from a satellite of a GNSS (Global Navigation Satellite System) such as a GPS (Global Positioning System) by a radio wave receiver, and sequentially detects, on the basis of the radio wave, a current position (latitude and longitude) of the drone Dn in the horizontal direction. Position information indicating the current position detected by the positioning unit 13 is output to the control unit 17. Furthermore, the positioning unit 13 may detect the current position (altitude) of the drone Dn in the vertical direction by the altitude sensor. In this case, the position information includes altitude information indicating the altitude of the drone Dn.

The communication unit 14 has an antenna and a wireless communication function, and is responsible for controlling communication performed via the communication network NW. The sensor unit 15 includes various sensors used to control the drone Dn. Examples of the various sensors include a compass (a geomagnetic sensor), a gyro (a triaxial angular speed sensor), a triaxial acceleration sensor, an atmospheric pressure sensor, a gimbal, an optical sensor, a range finder (a distance meter), and the like. The optical sensor includes a camera (for example, an RGB camera and an IR (Infrared ray) camera) and the like. Sensing information sensed by the sensor unit 15 is output to the control unit 17. The storage unit 16 includes a nonvolatile memory or the like, and stores various programs and data. Moreover, the storage unit 16 stores a vehicle ID (identification information) for identifying the drone Dn.

The control unit 17 includes at least one CPU (Central Processing Unit), an ROM (Read Only Memory), an RAM (Random Access Memory), and the like, and controls the drone Dn on the basis of the position information from the positioning unit 13 and the sensing information from the sensor unit 15. Such control includes control of a rotation speed of a propeller, control of a position, a posture, and a traveling direction of the drone Dn, and the like. The position information (that is, the position information from the positioning unit 13) of the drone Dn is transmitted to the GCS via the communication network NW together with the vehicle ID of the drone Dn. Then, the position information and the vehicle ID of the drone Dn are transmitted from the GCS to the base management server MS. Incidentally, the position information and the vehicle ID of the drone Dn may be transmitted from the drone Dn to the base management server MS.

Moreover, the control unit 17 has a self-diagnosis function, and performs inspection for each item (each inspection item) on whether a predetermined portion (for example, the power supply unit 11, the drive unit 12, the positioning unit 13, the communication unit 14, the sensor unit 15, or the like) of the drone Dn normally operates. Hereinafter, the inspection of the drone Dn performed by the drone Dn itself (that is, the control unit 17) is referred to as “automatic inspection”. The items of the automatic inspection include, for example, a remaining battery capacity, a battery cell balance, a GPS, a compass, a gyro, an acceleration sensor, an atmospheric pressure sensor, a gimbal, an optical sensor, a range finder, and the like. Incidentally, in the following description, the manual inspection and the automatic inspection may be collectively referred to simply as “inspection”. A result of the automatic inspection (for example, a result for each item) and automatic inspection result information including the vehicle ID of the drone Dn that has performed the automatic inspection are transmitted to the GCS via the communication network NW. Then, the automatic inspection result information is transmitted from the GCS to the base management server MS. Incidentally, the automatic inspection result information may be transmitted from the drone Dn to the base management server MS.

### [1-2. Configuration and Function of Worker Terminal Tm]

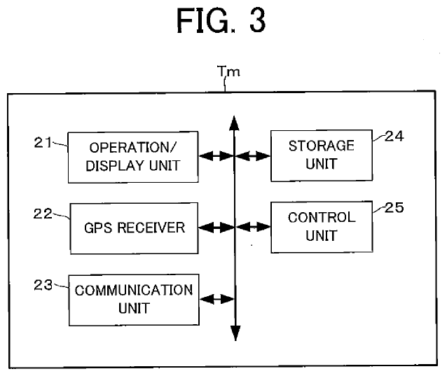

Next, a configuration and a function of the worker terminal Tm will be described with reference to FIG. 3. FIG. 3 is a diagram illustrating a schematic configuration example of the worker terminal Tm. The worker terminal Tm includes an operation/display unit 21, a GPS receiver 22, a communication unit 23, a storage unit 24, a control unit 25, and the like. Incidentally, as the worker terminal Tm, for example, a portable terminal such as a smartphone or a tablet, or a notebook personal computer can be applied. The worker terminal Tm may include a voice processing unit and a speaker. The operation/display unit 21 has, for example, an input function of receiving an instruction (an input instruction, a selection instruction, or the like) by a finger, a pen, or the like of the worker, and a display function of displaying various screens on the display. The GPS receiver 22 receives, for example, a radio wave transmitted from a GPS satellite, and detects the current position of the worker terminal Tm. The position information (latitude and longitude) indicating the position detected by the GPS receiver 22 is output to the control unit 25.

The communication unit 23 has a wireless communication function and is responsible for controlling communication performed via the communication network NW. The storage unit 24 includes a nonvolatile memory or the like, and stores various programs and pieces of data. The various programs include an operating system (OS), a worker application, and a web browser. The worker application is mainly a program for acquiring, from the base management server MS, the drone list including the inspection status of each of the plurality of drones Dn under the control of the drone base Bm that the worker Wm is in charge of, and displaying the acquired drone list. Incidentally, the worker application may be downloaded from a predetermined server to the worker terminal Tm.

The control unit 25 (an example of a computer) includes at least one CPU, an ROM, an RAM, and the like, and executes processing according to the worker application stored in the ROM (alternatively, the storage unit 24). When the worker application is activated in response to an instruction of the worker Wm, the control unit 25 displays a login screen on the display. Then, when a user ID and a password are input by the worker Wm through the login screen, the control unit 25 transmits a login request including the user ID and the password to the base management server MS via the communication unit 23 and the communication network NW. The user ID is identification information for identifying the worker Wm. Incidentally, the login request may include position information (that is, the position information from the GPS receiver 22) of the worker terminal Tm. The position information of the worker terminal Tm may be transmitted to the base management server MS together with the user ID of the worker Wm even after the worker Wm logs in.

Then, when the worker Wm logs in in response to the login request, display data for displaying the drone list is transmitted from the base management server MS, in which the drone list includes the inspection status of each of the plurality of drones Dn under the control of the drone base Bm that the logged-in worker Wm is in charge of. As a result, the control unit 25 displays a drone list screen on the display, and displays the drone list received by the communication unit 23 on the drone list screen. Incidentally, the display data may include a notification message to the worker Wm regarding the drone Dn. Moreover, the display data may be data of a web page displayed by a web browser.

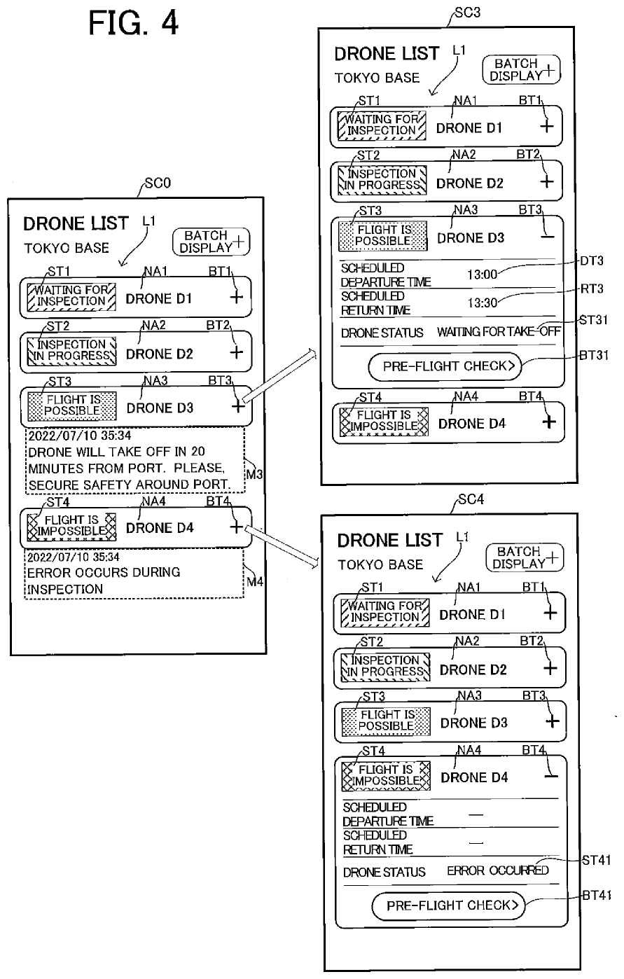

FIG. 4 is a diagram illustrating an example of the drone list screen. As illustrated in FIG. 4, a drone list screen SC0 displays a drone list L1 including names (which may be vehicle IDs) NA1 to NA4, inspection statuses ST1 to ST4, and detailed display buttons BT1 to BT4 of the drones D1 to D4 under the control of the drone base B1 that the logged-in worker W1 is in charge of. Further, a notification message M3 for the worker W1 regarding the drone D3 and a notification message M4 for the worker W1 regarding the drone D4 are displayed on the drone list screen SC0. These notification messages M3 and M4 can promptly call the worker W1's attention. Incidentally, the notification messages M3 and M4 may be displayed on a notification screen different from the drone list screen.

In the example of FIG. 4, the inspection status ST1 is “waiting for inspection” (inspection preparation in progress). The “waiting for inspection” means, for example, a state before a start of the manual inspection performed by the worker W1. The “waiting for inspection” may include waiting for automatic inspection performed by the drone D3. The inspection status ST2 is “inspection in progress”. The “inspection in progress” means, for example, a state in which the manual inspection by the worker W1 is in progress. The “inspection in progress” may include a state in which the automatic inspection by the drone D3 is in progress. The “waiting for inspection” and the “inspection in progress” are examples of the implementation status of the inspection of the drone Dn. As a result, the worker W1 can easily grasp the execution status of the inspection of the drone D3 at a glance.

On the other hand, the inspection status ST3 is “flight is possible”. The “flight is possible” means that the drone D3 is in a state in which the drone D3 can fly (can take-off) because no abnormality is found in the manual inspection performed by the worker W1. The fact that no abnormality is found may include the fact that no abnormality is found in the automatic inspection performed by the drone D3. Moreover, the inspection status ST4 is “flight is impossible”. The “flight is impossible” means that the drone D4 is in a state in which the drone D4 cannot fly because an abnormality is found in the automatic inspection performed by the drone D4. The “flight is possible” and the “flight is impossible” are determined on the basis of the result of inspection of the drone Dn. As a result, the worker W1 can easily grasp the inspection result of the drone D4 at a glance. Incidentally, instead of the “flight is possible” and the “flight is impossible”, “inspection completion (normal completion)” and “error occurrence” may be used.

The detailed display buttons BT1 to BT4 are buttons for displaying detailed information of the drones D1 to D4. For example, when the detailed display button BT3 is designated by the worker W1 on the drone list screen SC0, as shown in a drone list screen SC3, a scheduled departure time DT3, a scheduled return time RT3, and a drone status ST31 are displayed as the detailed information of the drone D3, and a screen display button BT31 for a pre-flight (before takeoff) check of the drone D3 is displayed. Here, the drone status ST31 indicates, for example, detailed contents (in this example, “waiting for take-off”) of the inspection status ST3. The pre-flight check includes, for example, input and confirmation of the result of the manual inspection and confirmation of the result of the automatic inspection.

On the other hand, in the drone list screen SC0 illustrated in FIG. 4, when the detailed display button BT4 is designated by the worker W1, as shown in a drone list screen SC4, a drone status ST41 is displayed as detailed information of the drone D4, and a screen display button BT41 for the pre-flight check of the drone D4 is displayed. Here, the drone status ST41 indicates, for example, detailed contents (in this example, “error occurred”) of the inspection status ST4. The drone status may indicate contents other than the detailed contents of the inspection status. For example, examples of the drone status include start of flight, during flight toward a destination such as a delivery destination, during delivery of an article at the destination, completion of article dropping at the destination, returning from the destination, completion of delivery, and the like. Incidentally, since the scheduled departure time and the scheduled return time of the drone D4 have not been determined (because of error occurrence), the same are not displayed.

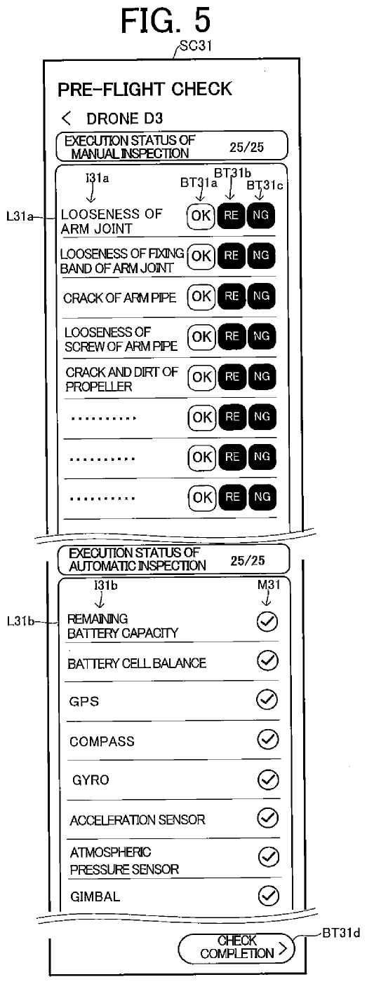

FIG. 5 is a diagram illustrating an example of a pre-flight check screen for the drone D3. For example, when the screen display button BT31 is designated by the worker W1 on the drone list screen SC3, a pre-flight check screen SC31 is displayed on the display, as illustrated in FIG. 5. The pre-flight check screen SC31 displays an item list of a manual inspection L31a and an item list of an automatic inspection L31b. Incidentally, on the pre-flight check screen SC31, an area that does not fall within a display range of the display is scrolled to be displayed. In the item list of the manual inspection L31a, an item (an inspection item) of the manual inspection I31a and inspection result input buttons BT31a to BT31c of the manual inspection are displayed for each item of the manual inspection. The manual inspection in this case is an inspection before the drone D3 takes off from the drone base B1.

In the example of FIG. 5, the number of items of the manual inspection is 25, but is not limited thereto. “OK” written on the inspection result input button BT31a indicates no abnormality, “RE” written on the inspection result input button BT31b indicates inspection suspension, and “NG” written on the inspection result input button BT31c indicates abnormality. The worker W1 can input and confirm the result of the manual inspection by selecting any one of the inspection result input buttons BT31a to BT31c for each item of the manual inspection. A result of the manual inspection (for example, a result for each item) input by the worker W1 through the operation/display unit 21 and manual inspection result information including the vehicle ID of the drone Dn subjected to the manual inspection are transmitted to the base management server MS together with the user ID via the communication network NW in response to a check completion instruction (for example, designation of a check completion button BT31d). Moreover, in the example of FIG. 5, a state in which the inspection result input button displayed in white is selected is illustrated, and a state in which the inspection result input button displayed in black is not selected is illustrated. In the example of FIG. 5, since the inspection result input buttons BT31a for all the items (25 items) of the manual inspection are selected, the results for all the items of the manual inspection indicate no abnormality. Incidentally, the item list of the manual inspection L31a may be included and displayed in the drone list L1 described above.

On the other hand, in the item list of the automatic inspection L31b, an item of an automatic inspection I31b and a result display mark of an automatic inspection M31 are displayed for each automatic inspection item. As a result, the worker W1 can confirm the result of the automatic inspection performed by the drone D3. The automatic inspection in this case is an inspection before the drone D3 takes off from the drone base B1. In the example of FIG. 5, the number of items of the automatic inspection is 25, but is not limited thereto. The result display mark of the automatic inspection M31 is displayed on the basis of the automatic inspection result information acquired from the base management server MS by the control unit 25. The automatic inspection result information includes a result for each item of the automatic inspection and the vehicle ID of the drone Dn on which the automatic inspection is performed. In the example of FIG. 5, the inspection result mark M31 for all items (25 items) of the automatic inspection indicates no abnormality. Incidentally, the item list of the automatic inspection L31b may be included and displayed in the drone list L1 described above.

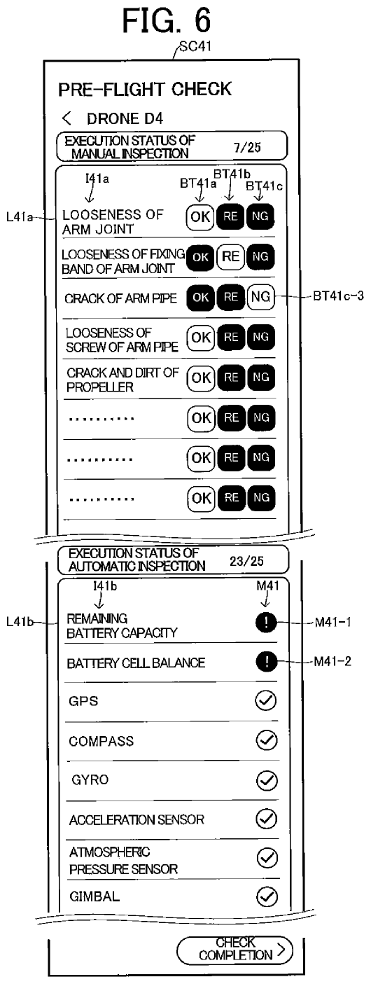

FIG. 6 is a diagram illustrating an example of a pre-flight check screen for the drone D4. For example, when the screen display button BT41 is designated by the worker W1 on the drone list screen SC4, a pre-flight check screen SC41 is displayed on the display, as illustrated in FIG. 6. The pre-flight check screen SC41 displays an item list of the manual inspection L41a and an item list of the automatic inspection L41b. In the item list of the manual inspection L41a, an item of the manual inspection I41a and inspection result input buttons BT41a to BT41c of the manual inspection are displayed for each item of the manual inspection. In the example of FIG. 6, since an inspection result input button BT41c-3 third from the top is selected among all the items of the manual inspection, the result of the manual inspection indicates that there is an abnormality. On the other hand, in the item list of the automatic inspection L41b, an item of the automatic inspection I41b and an inspection result mark of the automatic inspection M41 are displayed for each automatic inspection item. In the example of FIG. 6, the first and second inspection result marks M41-1 and M41-2 from the top indicate the presence of abnormality among all the items of the automatic inspection.

### [1-3. Configuration and Function of Base Management Server MS]

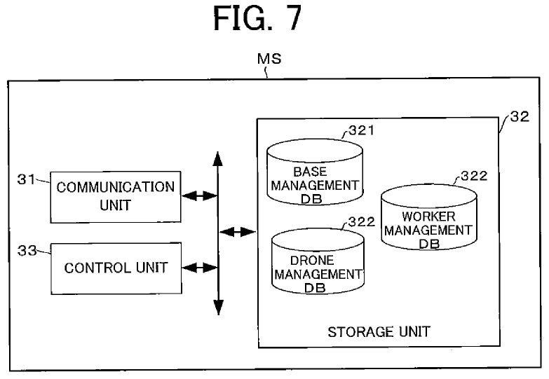

Next, a configuration and a function of the base management server MS will be described with reference to FIG. 7. FIG. 7 is a diagram illustrating a schematic configuration example of the base management server MS. As illustrated in FIG. 7, the base management server MS includes a communication unit 31, a storage unit 32, a control unit 33, and the like. The communication unit 31 controls communication performed via the communication network NW. The automatic inspection result information, the position information of the drone Dn, and the vehicle ID transmitted from the GCS or the drone Dn are received by the communication unit 31. The base management server MS can recognize the current position of the drone Dn from the position information of the drone Dn. The login request transmitted from the worker terminal Tm is received by the communication unit 31. Moreover, the manual inspection result information, the position information of the worker terminal Tm, and the user ID of the worker Wm transmitted from the worker terminal Tm after the login of the worker Wm are received by the communication unit 31. The base management server MS can recognize the current position of the worker Wm using the worker terminal Tm on the basis of the position information of the worker terminal Tm.

The storage unit 32 includes, for example, a hard disk drive or the like, and stores an operating system, various programs including an application, and the like. Here, the application includes a program for executing an information processing method. The program may be stored in a non-transitory computer readable memory. Furthermore, a base management database (DB) 321, a drone management database (DB) 322, and a worker management database (DB) 323 are constructed in the storage unit 32.

The base management database 321 is a database for managing information on the drone base Bm. In the base management database 321, for example, the base ID of the drone base Bm, the position information of an installation area of the drone base Bm, the vehicle ID of the drone Dn under the control of the drone base Bm, and the like are stored in association with each drone base Bm. Here, the base ID is identification information for identifying the drone base Bm. The position information of the installation area of the drone base Bm is represented by, for example, latitude and longitude in the installation area of the drone base Bm.

The drone management database 322 is a database for managing information on the drone Dn. In the drone management database 322, the vehicle ID, the name, the position information, the inspection result information, the inspection status, and the like of the drone Dn are stored in association with each drone Dn. Here, the inspection result information includes the latest result for each item of the manual inspection and the latest result for each item of the automatic inspection. The inspection result information is updated, for example, every time the communication unit 31 receives the manual inspection result information or the automatic inspection result information. As described above, the inspection status may include detailed information (for example, the scheduled departure time and the scheduled return time) of the drone Dn. Incidentally, the position information and the inspection status of the drone Dn are updated as appropriate.

The worker management database 323 is a database for managing information on the worker Wm. In the worker management database 323, a user ID, a password, a login status, a name, and the like of the worker Wm are stored in association with each worker Wm. Here, the login status indicates whether the worker Wm logs in. When the worker Wm logs in, the position information of the worker terminal Tm used by the worker Wm is stored in the worker management database 323 in association with the user ID of the worker Wm. Incidentally, when the drone base Bm that the worker Wm is in charge of is determined, the base ID of the drone base Bm that the worker Wm is in charge of is stored in the worker management database 323 in association with the user ID of the worker Wm.

The control unit 33 (an example of a computer) includes at least one CPU, an ROM, an RAM, and the like, and performs various processes according to the programs (program code) stored in the storage unit 32 or the non-transitory computer readable memory. The CPU (an example of processor) is configured to access the program code stored in the storage unit 32 or the memory and operate as instructed by the program code. The program code includes: login processing code configured to cause the CPU to perform login processing of the worker Wm who performs the inspection for the drone Dn at the drone base Bm where the drone Dn is allowed to take off or land in response to a login request from the worker Wm terminal Tm used by the worker Wm; base identification code configured to cause the CPU to identify, when the worker Wm logs in by the login processing, the drone base Bm that the worker Wm is in charge of; and display control code configured to cause the CPU to display, on the worker terminal Tm, a drone list including respective current states of a plurality of the drone Dn under control of the identified drone base Bm. Moreover, the program code may include position identification code configured to cause the CPU to identify a position when the worker Wm logs in. Moreover, the program code may include: first position identification code configured to cause the CPU to identify a first position of the drone Dn for which the inspection has been completed; second position identification code configured to cause the CPU to identify a second position of the worker Wm after the inspection has been completed; determination code configured to cause the CPU to determine, when the drone Dn for which the inspection has been completed, reaches a predetermined time before a scheduled departure time thereof, whether a distance between the first position and the second position is equal to or less than a threshold value; and notification code configured to cause the CPU to issue, in a case where it is determined that that the distance is equal to or less than the threshold value, a notification of urging the worker Wm to retreat (evacuate) from the first position. Moreover, the program code may include: first acquisition code configured to cause the CPU to acquire a result of the inspection, the result being input by the worker Wm in the worker terminal Tm; and first update code configured to cause the CPU to update, based on the acquired result of the inspection, the current state of the drone Dn. Moreover, the program code may include: second acquisition code configured to cause the CPU to acquire a result of an automatic inspection performed by the drone Dn; and second update code configured to cause the CPU to update, based on the acquired result of the automatic inspection, the current state of the drone Dn.

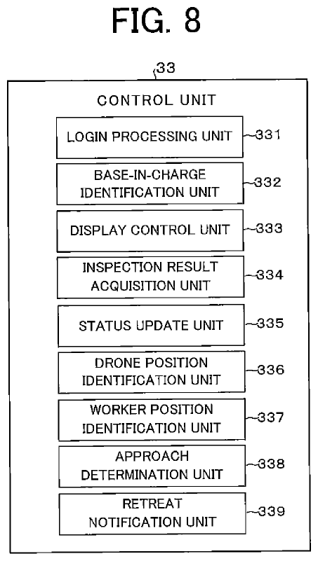

FIG. 8 is a diagram illustrating an example of functional blocks in the control unit 33. For example, according to the program (the program code), the control unit 33 functions as a login processing unit 331, a base-in-charge identification unit 332, a display control unit 333, an inspection result acquisition unit 334, a status update unit 335, a drone position identification unit 336, a worker position identification unit 337, an approach determination unit 338, a retreat notification unit 339, and the like, as illustrated in FIG. 8.

The login processing unit 331 performs login processing of the worker Wm in response to a login request from the worker terminal Tm. In the login processing, it is determined whether a set of the user ID and the password included in the login request is registered. Then, when the set of the user ID and the password is registered, the worker Wm who uses the worker terminal Tm that has transmitted the login request is identified (identified by the user ID), and the worker Wm logs in.

When the worker Wm is identified by the login processing, the base-in-charge identification unit 332 identifies the drone base Bm that the worker Wm is in charge of. For example, in the worker management database 323, the drone base Bm identified by the base ID stored in association with the user ID of the logged-in worker Wm is identified as the drone base Bm that the worker Wm is in charge of.

The display control unit 333 transmits, to the worker terminal Tm that has transmitted the login request, display data for displaying the drone list including the inspection status of each of the plurality of drones Dn under the control of the drone base Bm identified by the base-in-charge identification unit 332, thereby, for example, displaying the drone list, as illustrated in FIG. 4. As a result, the worker Wm can easily grasp the inspection status of each drone Dn under the control of the drone base Bm that the worker Wm himself or herself is in charge of at a glance.

Incidentally, when the base ID of the drone base Bm that the logged-in worker Wm is in charge of is not stored in the worker management database 323 in association with the user ID of the worker Wm, the base-in-charge identification unit 332 may identify the position when the worker Wm logs in. For example, when the position information of the worker terminal Tm is included in the login request, the base-in-charge identification unit 332 identifies the position indicated by the position information as a position when the worker Wm logs in. On the other hand, when the position information of the worker terminal Tm is not included in the login request, the base-in-charge identification unit 332 may request the position information to the worker terminal Tm of the worker Wm when the worker Wm logs in. In this case, the base-in-charge identification unit 332 acquires the position information transmitted from the worker terminal Tm in response to the request for the position information, and identifies the position indicated by the position information as the position when the worker Wm logs in.

Then, the base-in-charge identification unit 332 identifies the drone base Bm that the worker Wm is in charge of, on the basis of the identified position (that is, the position of the logged-in worker Wm) and the position information indicating the installation area of each drone base Bm managed by the base management database 321. For example, the drone base Bm corresponding to the installation area including the position of the logged-in worker Wm is identified. As a result, even when the worker Wm works at the drone base Bm different from the usual drone base Bm, the worker Wm can grasp the drone list of the drones Dn under the control of the drone base Bm together with the inspection status only by logging in at the drone base Bm at which the worker Wm is scheduled to work.

The inspection result acquisition unit 334 acquires, via the communication unit 31, the manual inspection result information including the result of the manual inspection (for example, the result for each item) input by the worker Wm in the worker terminal Tm as described above. The manual inspection result information includes the vehicle ID of the drone Dn subjected to the manual inspection. Moreover, the inspection result acquisition unit 334 acquires, via the communication unit 31, the automatic inspection result information including the result of the automatic inspection performed by the drone Dn (for example, the result for each item) and the vehicle ID of the drone Dn on which the automatic inspection has been performed.

The status update unit 335 updates (that is, updates the inspection status of the drone Dn in the drone management database 322) the inspection status of the drone Dn identified by the vehicle ID included in the manual inspection result information on the basis of the result included in the manual inspection result information acquired by the inspection result acquisition unit 334. For example, the inspection status is updated from “waiting for inspection” to “inspection in progress” or “inspection completion”. Moreover, on the basis of the result included in the automatic inspection result information acquired by the inspection result acquisition unit 334, the inspection status of the drone Dn identified by the vehicle ID included in the automatic inspection result information is updated.

Then, when the inspection status is updated by the status update unit 335, the display control unit 333 controls to display the drone list by transmitting the display data for displaying the drone list including the updated inspection status to the worker terminal Tm that has transmitted the login request. As a result, the worker Wm can easily grasp the latest inspection status of the drone Dn updated on the basis of the result of the manual inspection performed by the worker Wm himself or herself at a glance. Moreover, the worker Wm can easily grasp the latest inspection status of the drone Dn updated on the basis of the result of the automatic inspection performed by the drone Dn at a glance.

The drone position identification unit 336 identifies a drone position (an example of a first position) of the drone Dn for which the inspection (the manual inspection, or the manual inspection and the automatic inspection) has been completed. The drone position is identified based on the position information acquired from the drone Dn. The worker position identification unit 337 identifies a worker position (an example of a second position) of the worker Wm after completion of the inspection (the manual inspection, or the manual inspection and the automatic inspection). The worker position is identified based on the position information acquired from the worker terminal Tm.

When the drone Dn for which the inspection (the manual inspection, or the manual inspection and the automatic inspection) has been completed, reaches a predetermined time before the scheduled departure time thereof, the approach determination unit 338 determines (that is, determines whether the drone Dn is approaching the worker) whether a distance between the drone position identified by the drone position identification unit 336 and the worker position identified by the worker position identification unit 337 is equal to or less than a threshold value.

When the approach determination unit 338 determines that the distance between the worker position and the drone position is equal to or less than the threshold value, the retreat notification unit 339 transmits, to the worker terminal Tm, information urging the worker Wm to retreat (evacuate) from the worker position, thereby issuing a notification of urging the worker Wm to perform the retreat. As a result, since the worker Wm uses the worker terminal Tm, the base management server MS can not only acquire the position information from the worker terminal Tm but also issue the notification of urging the worker Wm to retreat from the worker position via the worker terminal Tm without using another device (for example, an alarm device) after the completion of the manual inspection, thereby making it possible to improve the safety of the worker Wm.

### 2. Operation of Drone Base System S

Next, an operation of the drone base system S will be described. Incidentally, in the following description of the operation, a description will be given, as an example, as to a case in which the worker W1 using the worker terminal T1 works at the drone base B1.

### (2-1. Drone List Display Processing)

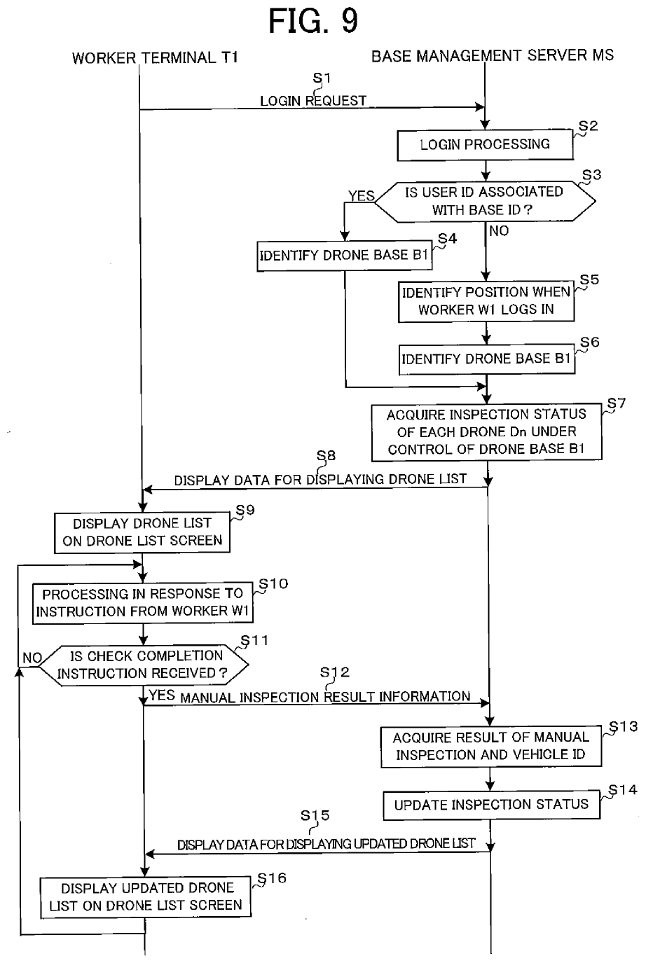

First, an operation when the drone list is displayed on the worker terminal T1 will be described with reference to FIG. 9. FIG. 9 is a sequence diagram illustrating an example of drone list display processing executed by the worker terminal T1 (the control unit 25) and the base management server MS (the control unit 33). In the worker terminal T1, when a worker application is activated in response to an instruction of the worker W1, a login screen is displayed on a display. Then, the worker terminal T1 transmits, to the base management server MS, a login request including a user ID and a password input by the worker W1 through the login screen (step S1).

Next, when receiving the login request from the worker terminal T1, the base management server MS performs login processing by the login processing unit 331 in response to the login request (step S2). In the login processing, it is determined whether a set of the user ID and the password included in the login request is registered. For example, when the set of the user ID and the password included in the login request is stored in the worker management database 323, it is determined that the set of the user ID and the password is registered, and the worker W1 using the worker terminal T1 logs in.

Next, the base management server MS refers to the worker management database 323 and determines whether the base ID is associated with the user ID of the logged-in worker W1 (step S3). When it is determined that the base ID is associated with the user ID of the worker W1 (step S3: YES), the processing proceeds to step S4. On the other hand, when it is determined that the base ID is not associated with the user ID of the worker W1 (step S3: NO), the processing proceeds to step S5.

In step S4, the base management server MS identifies, based on the base ID associated with the user ID of the worker W1, the drone base B1 that the worker W1 is in charge of by the base-in-charge identification unit 332. On the other hand, in step S5, as described above, the base management server MS identifies, based on the position information acquired from the worker terminal T1, a position when the worker W1 logs in by the base-in-charge identification unit 332. Next, on the basis of the position identified in step S4 and the position information indicating the installation area of each drone base B1 managed in the base management database 321, the base management server MS identifies the drone base B1 that the worker W1 is in charge of by the base-in-charge identification unit 332 as described above (step S6).

Next, the base management server MS acquires, from the drone management database 322, an inspection status and the like of each of the drones D1 to D4 under the control of the drone base B1 identified in step S4 or step S6 (step S7). At this time, inspection result information of each of the drones D1 to D4 may be acquired from the drone management database 322. Next, the base management server MS transmits display data for displaying a drone list including the inspection status, the vehicle ID, and the like acquired in step S7 to the worker terminal T1 by the display control unit 333 (step S8). Incidentally, the display data may include the inspection result information of each of the drones D1 to D4.

Next, when receiving the display data for displaying the drone list from the base management server MS, the worker terminal T1 displays the drone list on a drone list screen, for example, as illustrated in FIG. 4 (step S9). Next, the worker terminal T1 performs processing in response to an instruction received from the worker W1 via the operation/display unit 21 (step S10). In such processing, for example, as illustrated in FIG. 4, the detailed information of the drone D3 is displayed on the drone list screen. Alternatively, as illustrated in FIG. 5, a pre-flight check screen for the drone D3 is displayed. The worker W1 selects an inspection result input button for each item of a manual inspection performed by the worker W1 himself or herself to input a result of the manual inspection. The result of the manual inspection input in this manner is temporarily stored in the RAM. Moreover, the worker W1 confirms a result of an automatic inspection performed by the drone D3.

Next, the worker terminal T1 determines whether a check completion instruction is received from the worker W1 via the operation/display unit 21 (step S11). When it is determined that the check completion instruction (for example, designation of the check completion button BT31d illustrated in FIG. 5) is received (step S11: YES), the processing proceeds to step S12. On the other hand, when it is determined that the check completion instruction is not received (step S11: NO), the processing returns to step S10. In step S12, the worker terminal T1 transmits, to the base management server MS, the manual inspection result information including the result of the manual inspection, input by the worker W1 and temporarily stored, together with the user ID. The manual inspection result information includes the vehicle ID of the drone D4 subjected to the manual inspection.

Next, when receiving the manual inspection result information from the worker terminal T1, the base management server MS acquires the result of the manual inspection and the vehicle ID from the manual inspection result information by the inspection result acquisition unit 334 (step S13). Next, the base management server MS updates, by the status update unit 335, the inspection status of the drone D4 identified by the vehicle ID on the basis of the result of the manual inspection and the vehicle ID acquired in step S13 (step S14). Next, the base management server MS transmits the display data for displaying the drone list (that is, the updated drone list) including the inspection status and the like updated in step S14 to the worker terminal T1 by the display control unit 333 (step S15).

Next, when receiving the display data for displaying the drone list from the base management server MS, the worker terminal T1 displays the received display data on the drone list screen including the drone list including the updated inspection status and the like (step S16). Thereafter, the processing returns to step S10, and, for example, the worker W1 performs the manual inspection on the drone D4 and inputs the result thereof.

### (2-2. Retreat Notification Processing)

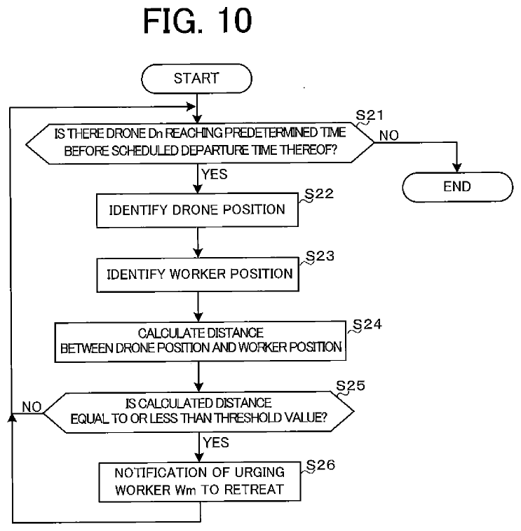

Next, a description will be given as to an operation at the time of issuing a notification of urging the worker Wm to retreat with reference to FIG. 10. FIG. 10 is a flowchart illustrating an example of retreat notification processing executed by the base management server MS (the control unit 33). Incidentally, as a premise of such an operation, for example, a scheduled departure time monitoring list is referred to, in which the scheduled departure time monitoring list registers the vehicle ID and the scheduled departure time of the drone Dn, the scheduled departure time of which is determined, among the drones Dn on which the inspection is completely performed. Here, the drone Dn on which the inspection is completely performed is, for example, the drone Dn that has received the automatic inspection result information and the manual inspection result information.

The processing illustrated in FIG. 10 is executed, for example, by the base management server MS at predetermined time intervals (for example, 1 minute). When the processing illustrated in FIG. 10 is started, the base management server MS compares the current time with the scheduled departure time registered in the scheduled departure time monitoring list, and determines whether there is a drone Dn that reaches the predetermined time before the scheduled departure time of the drone Dn (step S21). When it is determined that there is the drone Dn that reaches the predetermined time before the scheduled departure time thereof (step S21: YES), the drone Dn is identified, and the processing proceeds to step S22. For example, assuming that the predetermined time is 5 minutes and the current time is “9:55”, the drone Dn, the scheduled departure time of which is “10:00”, is identified. On the other hand, when it is determined that there is no drone Dn that reaches the predetermined time before the scheduled departure time thereof (step S21: NO), the processing ends.

In step S22, the base management server MS identifies the drone position of the drone Dn identified in step S21 by the drone position identification unit 336. For example, the drone position identification unit 336 acquires position information of the drone Dn by requesting the position information to the drone Dn. Then, the drone position identification unit 336 identifies the drone position of the drone Dn on the basis of the acquired position information.

Next, the base management server MS identifies, by the worker position identification unit 337, the worker position of the worker Wm who has performed the manual inspection of the drone Dn identified in step S21 (step S23). For example, the worker position identification unit 337 acquires position information of the worker terminal T1 by requesting the position information to the worker terminal T1 (that is, the worker terminal T1 that has transmitted the manual inspection result information of the drone D3) used by the worker W1. Then, the worker position identification unit 337 identifies the worker position of the worker Wm on the basis of the acquired position information.

Next, the base management server MS calculates a distance between the drone position identified in step S22 and the worker position identified in step S23 (step S24). Next, the base management server MS determines whether the distance calculated in step S24 is equal to or less than a threshold value (for example, 50 cm to 2 m) by the approach determination unit 338 (step S25). When it is determined that the calculated distance is not equal to or less than the threshold value (step S25: NO), the processing returns to step S21. On the other hand, when it is determined that the calculated distance is equal to or less than the threshold value (step S25: YES), the base management server MS transmits information for urging the worker to retreat from the worker position to the worker terminal T1, thereby issuing a notification of urging the worker Wm to retreat (step S26). Thereafter, the processing returns to step S21. Returning to step S21, it is determined whether there is another drone Dn that reaches the predetermined time before the scheduled departure time thereof, and processing similar to the above-described processing is performed.

As described above, according to the embodiments, the base management server MS performs the login processing of the worker Wm in response to the login request from the worker terminal Tm used by the worker Wm, identifies the drone base Bm (base in charge) that the worker Wm is in charge of when the worker Wm logs in by the login processing, and displays the drone list including the inspection status of each drone Dn under the control of the identified drone base Bm on the worker terminal Tm. Therefore, the worker Wm can easily grasp the inspection status of each drone Dn under the control of the drone base Bm that the worker Wm is in charge of at a glance, thereby making it possible to improve efficiency of the inspection of each drone Dn under the control of the drone base Bm.

Incidentally, the above-described embodiment is one embodiment of the present invention, and the present invention is not limited to the above-described embodiment, changes from the above-described embodiment can be made on various configurations and the like within a scope not departing from the gist of the present invention, and such cases shall be also included in the technical scope of the present invention. In the above embodiment, a description has been given as to an example in which the drone list is displayed on the worker terminal Tm used by the worker Wm who performs the inspection before the drone Dn takes off. However, the drone list may be displayed on the worker terminal Tm used by the worker Wm who performs the inspection when the drone Dn returns to the drone base Bm and lands or the inspection when the drone Dn is subjected to maintenance at the drone base Bm. Moreover, in the embodiment, the drone has been described as an example of the unmanned flying object, but the present invention is also applicable to a flying robot other than the drone. Moreover, in the embodiment, it is determined whether the base ID is associated with the user ID of the logged-in worker W1, and when it is determined that the base ID is not associated with the user ID of the logged-in worker W1, the base in charge is identified on the basis of the position information of the worker W1. However, the present invention is not limited thereto, and the base in charge may be identified on the basis of the position information of the worker W1 without determining whether the base ID is associated with the user ID of the logged-in worker W1.

### <Note>

[1] An information processing device according to the present disclosure includes: a login processing unit configured to perform login processing of a worker who performs an inspection on an unmanned aerial vehicle at a base where the unmanned aerial vehicle is allowed to take off or land in response to a login request from a terminal used by the worker; a base identification unit configured to identify, when the worker logs in by the login processing, the base that the worker is in charge of; and
a display control unit configured to display, on the terminal, a list including respective current states of a plurality of the unmanned aerial vehicles under control of the base identified by the base identification unit. Thus, the worker can easily grasp the current state of each unmanned aerial vehicle under the control of the base that the worker is in charge of at a glance, thereby making it possible to improve efficiency of the inspection of each the unmanned aerial vehicle under the control of the base.

[2] The information processing device described in [1] above, further includes a position identification unit configured to identify a position when the worker logs in, wherein the base identification unit identifies, based on the position identified by the position identification unit, the base that the worker is in charge of. Thus, even when the worker works at the base different from the usual base, the worker can grasp the list of the unmanned aerial vehicle under the control of the base together with the current state only by logging in at the base at which the worker is scheduled to work.

[3] The information processing device described in [1] or [2] above, further includes: a first position identification unit configured to identify a first position of the unmanned aerial vehicle, the inspection of which is completed; a second position identification unit configured to identify a second position of the worker after the inspection is completed; a determination unit configured to determine, when the unmanned aerial vehicle, the inspection of which is completed, reaches a predetermined time before a scheduled departure time thereof, whether a distance between the first position and the second position is equal to or less than a threshold value; and a notification unit configured to issue, when the determination unit is configured to determine that the distance is equal to or less than the threshold value, a notification of urging the worker to retreat from the first position. This makes it possible to improve the safety of the worker without using another device after the completion of the inspection by the worker because the worker uses the terminal.

[4] In the information processing device described in any one of [1] to [3] above, the current state of the unmanned aerial vehicle includes at least one of an execution status of the inspection of the unmanned aerial vehicle and a result of the inspection of the unmanned aerial vehicle. Thus, the worker can easily grasp at least one of the execution status of the inspection of each unmanned aerial vehicle and the result of the inspection of each unmanned aerial vehicle at a glance.

[5] In the information processing device described in [4] above, the inspection includes a manual inspection of the unmanned aerial vehicle, the manual inspection being performed by the worker, and an automatic inspection performed by the unmanned aerial vehicle. Thus, the worker can easily grasp at least one of the execution status of the manual inspection and the result of the manual inspection at a glance. Further, the worker can easily grasp at least one of the execution status of the automatic inspection of each unmanned aerial vehicle and the result of the automatic inspection at a glance.

[6] In the information processing device described in any one of [1] to [5] above, the inspection is an inspection performed before the unmanned aerial vehicle takes off from the base. Thus, the worker can easily grasp the latest state before each unmanned aerial vehicle takes off at a glance.

[7] The information processing device described in any one of [1] to [6] above, further includes: a first acquisition unit configured to acquire a result of the inspection, the result being input by the worker in the terminal; and a first update unit configured to update, based on the result of the inspection acquired by the first acquisition unit, the current state of the unmanned aerial vehicle, wherein the display control unit is configured to display, on the terminal, the list including the current state of the unmanned aerial vehicle, wherein the current state is updated by the first update unit. Thus, the worker can easily grasp the latest state of the unmanned aerial vehicle, updated based on the result of the manual inspection performed by the worker himself at a glance.

[8] The information processing device described in any one of [1] to [7] above, further includes: a second acquisition unit configured to acquire a result of an automatic inspection performed by the unmanned aerial vehicle; and a second update unit configured to update, based on the result of the automatic inspection acquired by the second acquisition unit, the current state of the unmanned aerial vehicle, wherein the display control unit is configured to display, on the terminal, the list including the current state of the unmanned aerial vehicle, wherein the current state is updated by the second update unit. Thus, the worker can easily grasp the latest state of the unmanned aerial vehicle, updated based on the result of the automatic inspection performed by the unmanned aerial vehicle at a glance.

[9] An information processing method according to the present disclosure includes: performing login processing of a worker who performs an inspection for an unmanned aerial vehicle at a base where the unmanned aerial vehicle is allowed to take off or land in response to a login request from a terminal used by the worker; identifying, when the worker logs in by the login processing, the base that the worker is in charge of; and displaying, on the terminal, a list including respective current states of a plurality of the unmanned aerial vehicles under control of the identified base.

[10] A program according to the present disclosure, is configured to cause a computer to: perform login processing of a worker who performs an inspection for an unmanned aerial vehicle at a base where the unmanned aerial vehicle is allowed to take off or land in response to a login request from a terminal used by the worker; identify, when the worker logs in by the login processing, the base that the worker is in charge of; and display, on the terminal, a list including respective current states of a plurality of the unmanned aerial vehicles under control of the identified base.

### REFERENCE SIGNS LIST

11 Power supply unit
12 Drive unit
13 Positioning unit
14 Communication unit
15 Sensor unit
16 Storage unit
17 Control unit
21 Operation/display unit
22 GPS receiver
23 Communication unit
24 Storage unit
25 Control unit
31 Communication unit
32 Storage unit
33 Control unit
331 Login processing unit
332 Base-in-charge identification unit
333 Display control unit
334 Inspection result acquisition unit
335 Status update unit
336 Drone position identification unit
337 Worker position identification unit
338 Approach determination unit
339 Retreat notification unit
Dn Drone
Tm Worker terminal
MS Base management server
S Drone base system

What is claimed is:

1. An information processing device comprising:
at least one memory configured to store program code; and at least one processor configured to access the program code and operate as instructed by the program code, the program code including:
login processing code configured to cause the at least one processor to perform login processing of a worker who performs an inspection for an unmanned aerial vehicle at a base where the unmanned aerial vehicle is allowed to take off or land in response to a login request from a terminal used by the worker;
base identification code configured to cause the at least one processor to identify, when the worker logs in by the login processing, the base that the worker is in charge of; and
display control code configured to cause the at least one processor to display, on the terminal, a list including respective current states of a plurality of the unmanned aerial vehicles under control of the identified base.

2. The information processing device according to claim 1, the program code further including position identification code configured to cause the at least one processor to identify a position when the worker logs in,
wherein the base identification code is configured to cause the at least one processor to identify, on the basis of the identified position, the base that the worker is in charge of.

3. The information processing device according to claim 1, the program code further including:
first position identification code configured to cause the at least one processor to identify a first position of the unmanned aerial vehicle for which the inspection has been completed;
second position identification code configured to cause the at least one processor to identify a second position of the worker after the inspection has been completed;
determination code configured to cause the at least one processor to determine, when the unmanned aerial vehicle for which the inspection has been completed, reaches a predetermined time before a scheduled departure time thereof, whether a distance between the first position and the second position is equal to or less than a threshold value; and
notification code configured to cause the at least one processor to issue, in a case where it is determined that that the distance is equal to or less than the threshold value, a notification of urging the worker to retreat from the first position.

4. The information processing device according to claim 1, wherein the current state of the unmanned aerial vehicle includes at least one of an execution status of the inspection for the unmanned aerial vehicle and a result of the inspection for the unmanned aerial vehicle.

5. The information processing device according to claim 4, wherein the inspection includes a manual inspection for the unmanned aerial vehicle, the manual inspection being performed by the worker, and an automatic inspection performed by the unmanned aerial vehicle.

6. The information processing device according to claim 5, wherein the inspection is an inspection performed before the unmanned aerial vehicle takes off from the base.

7. The information processing device according to claim 1, the program code further including:
first acquisition code configured to cause the at least one processor to acquire a result of the inspection, the result being input by the worker in the terminal; and
first update code configured to cause the at least one processor to update, on the basis of the acquired result of the inspection, the current state of the unmanned aerial vehicle,
wherein the display control code is configured to cause the at least one processor to display, on the terminal, the list including the updated current state of the unmanned aerial vehicle.

8. The information processing device according to claim 1, the program code further including:
second acquisition code configured to cause the at least one processor to acquire a result of an automatic inspection performed by the unmanned aerial vehicle; and
second update code configured to cause the at least one processor to update, on the basis of the acquired result of the automatic inspection, the current state of the unmanned aerial vehicle,
wherein the display control code is configured to cause the at least one processor to display, on the terminal, the list including the updated current state of the unmanned aerial vehicle.

9. An information processing method executed by one or more computers, comprising:
performing login processing of a worker who performs an inspection for an unmanned aerial vehicle at a base where the unmanned aerial vehicle is allowed to take off or land in response to a login request from a terminal used by the worker;
identifying, when the worker logs in by the login processing, the base that the worker is in charge of; and
displaying, on the terminal, a list including respective current states of a plurality of the unmanned aerial vehicles under control of the identified base.

10. A non-transitory computer readable memory having stored thereon a program configured to cause a computer to:
perform login processing of a worker who performs an inspection for an unmanned aerial vehicle at a base where the unmanned aerial vehicle is allowed to take off or land in response to a login request from a terminal used by the worker;
identify, when the worker logs in by the login processing, the base that the worker is in charge of; and
display, on the terminal, a list including respective current states of a plurality of the unmanned aerial vehicles under control of the identified base.
